(19) United States
(12) Patent Application Publication
(10) Pub. No.: US 2004/0131065 A1
(43) Pub. Date: Jul. 8, 2004

(54) Distributed switch fabric network and method

(76) Inventors: Douglas L. Sandy, Chandler, AZ (US); Ralph Snowden, Gilbert, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/340,516

(22) Filed: Jan. 8, 2003

(51) Int. Cl. H04L 12/28

(52) U.S. Cl. 370/400; 370/404

(57) ABSTRACT

A distributed switch fabric network (200) includes a plurality of nodes (202-210), where each of the plurality of nodes includes at least a portion of a switching function (220-228). A plurality of receiver channels (434, 436, 438) within each of the plurality of nodes, where the plurality of receiver channels are coupled to receive a plurality of packets (414, 416, 418), and where the plurality of receiver channels aggregate in a plurality of stages (451) within the node. A shared memory resource (409) within each of the plurality of nodes, wherein the shared memory resource is coupled to receive the plurality of packets from the plurality of receiver channels.

### BACKGROUND OF THE INVENTION

Advances in high-speed serial interconnects are enabling switch fabric “mesh” topologies to replace traditional bus-based architectures. Such switch fabric topologies allow the use of distributed switch fabrics, which offer advantages in cost, scalability, availability and interoperability over bus-based architectures. In a distributed switch fabric, the ability to process packets from any of the fabric nodes can create large memory buffer requirements and very high clocking rates if traditional packet buffering arrangements are used.

Accordingly, there is a significant need for an apparatus and method that overcomes the disadvantages of the prior art outlined above.

### BRIEF DESCRIPTION OF THE DRAWINGS

Referring to the drawing:

FIG. 1 depicts a block diagram of a prior art switch fabric network;

FIG. 2 depicts a block diagram of a distributed switch fabric network according to an embodiment of the invention;

FIG. 3 illustrates a block diagram of a distributed switch fabric network according to an embodiment of the invention;

FIG. 4 illustrates a block diagram of a distributed switch fabric network according to another embodiment of the invention; and

FIG. 5 illustrates a flow diagram of a method of the invention according to an embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical, electrical, or logical contact. However, “coupled” may mean that two or more elements are not in direct contact with each other, but yet still co-operate or interact with each other.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

Although many topologies exist for wiring together systems to transport information, the two most common prior art topologies are bus, and star topologies. Bussed topologies use a multi-drop configuration to connect a variety of resources. Busses are usually wide and slow relative to other topologies. Busses rapidly reach a point of diminishing returns, with reliability becoming problematic as any resource on the bus can compromise the integrity of the whole system.

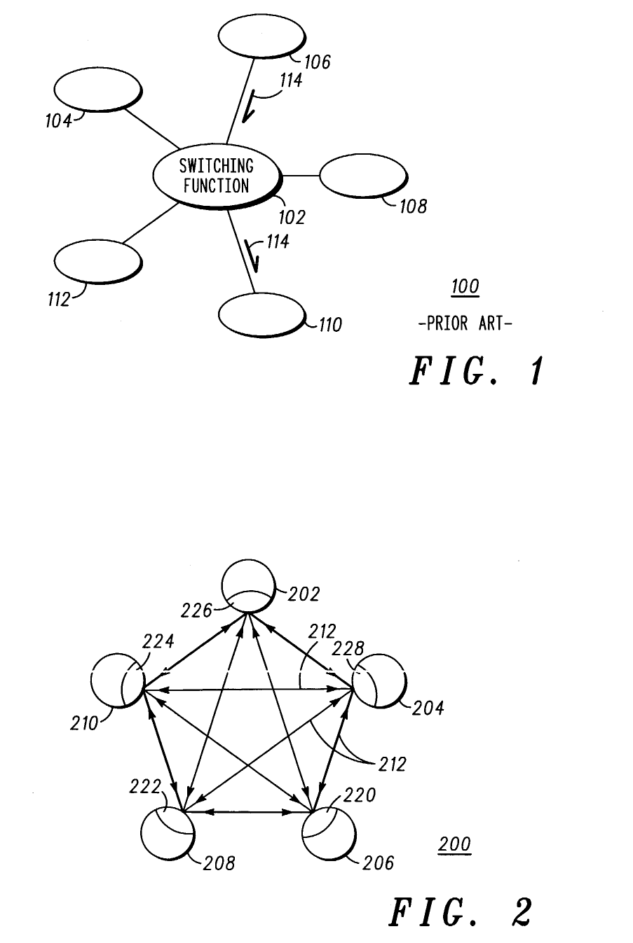

FIG. 1 depicts a block diagram of a prior art switch fabric network 100. As shown in FIG. 1, a star topology uses point-to-point connections where each node 104-112 uses a dedicated link to send/receive data from a central resource or switching function 102. Data can be in the form of packets 114. As is known in the art, packets 114 generally comprise a header portion that instructs the switching function as to the destination node of the packet 114. In the prior art switch fabric 100 of FIG. 1, each packet sent by a node 104-112 must pass through switching function 102 so that switching function 102 can route the packet to its destination node.

Switching function 102 is usually manifested as a switch card in a chassis. The switch function 102 provides the data/packet distribution for the system. Each node 104-112 can be an individual payload or a sub-network, and can be a leg on a star of the next layer in the hierarchy. Star topologies require redundancy to provide reliability. Reliance on a single switching function can cause a loss of all elements below a failure point. A “dual star” topology (known in the art) is often used for high availability applications. However, even in a “dual star” configuration, the star topology still has a “choke” point that restrict the speed and efficiency of packet transfer and create a potential failure point within a network.

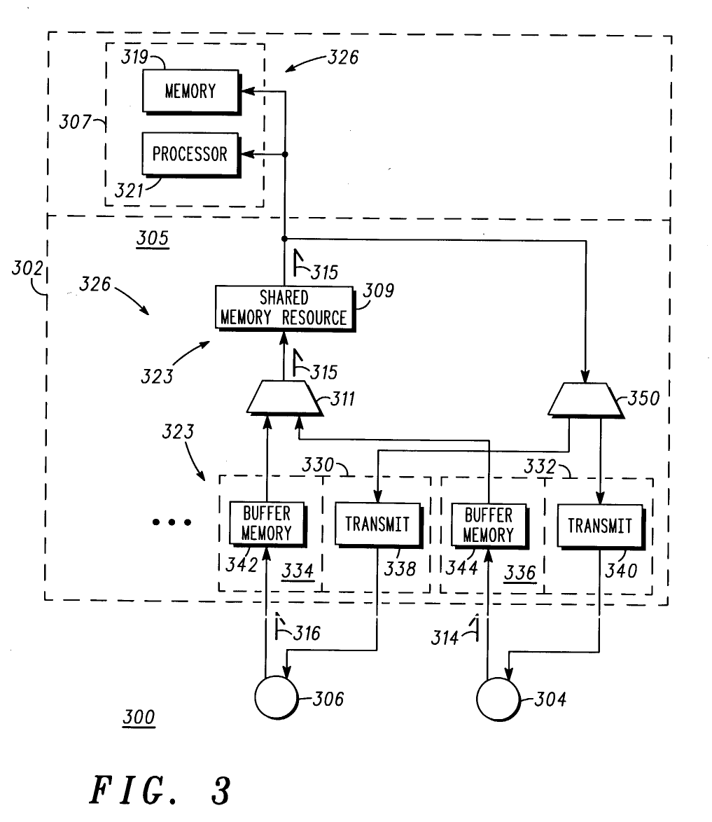

FIG. 2 depicts a block diagram of a distributed switch fabric network 200 according to an embodiment of the invention. As shown in FIG. 2, distributed switch fabric network 200 populates point-to-point connections until all nodes 202-210 have connections to all other nodes 202-210. In this configuration, distributed switch fabric network 200 creates a fully populated, non-blocking fabric. Distributed switch fabric network 200 has a plurality of nodes 202-210 coupled to mesh network 212, in which each node 202-210 has a direct route to all other nodes and does not have to route traffic for other nodes. Instead of the conventional N×N switch in a star topology, each node 202-210 in distributed switch fabric network 200 uses an M, 1×N switch.

In this configuration, the hierarchy found in a star network disappears. Each point can be an endpoint, a router, or both. In distributed switch fabric network 200 each node switches its own traffic (i.e. packets), and therefore has a portion of switching function 220-228. There is no dependence on a central switching function, as all nodes 202-210 are equal in a peer-to-peer system. In other words, each of nodes 202-210 includes at least a portion of switching function 220-228.

The physical layer for interfacing distributed switch fabric network 200 can use, for example and without limitation, 100 ohm differential transmit and receive pairs per channel. Each channel can use high-speed serialization/deserialization (SERDES) and 8b/10b encoding at speeds up to 3.125 Gigabits per second (Gb/s).

Distributed switch fabric network 200 can utilize, for example and without limitation, Common Switch Interface Specification (CSIX) for communication between nodes 202-210. CSIX defines electrical and packet control protocol layers for traffic management and communication. Packet traffic can be serialized over links suitable for a backplane environment. The CSIX packet protocol encapsulates any higher-level protocols allowing interoperability in an open architecture environment.

Distributed switch fabric network 200 can use any network standard for switch fabric networks in open architecture platforms. For example, in an embodiment distributed switch fabric network 200 can use the CompactPCI Serial Mesh Backplane (CSMB) standard as set forth in PCI Industrial Computer Manufacturers Group (PCIMG®) specification 2.20, published by PCIMG, 301 Edgewater Place, Suite 220, Wakefield, Mass. CSMB provides infrastructure for applications such as Asynchronous Transfer Mode (ATM), 3G wireless, other proprietary or consortium based transport protocols, and the like. In another embodiment distributed switch fabric network 200 can use an Advanced Telecom and Computing Architecture (AdvancedTCA™) standard as set forth by PCIMG.

FIG. 3 illustrates a block diagram of a distributed switch fabric network 300 according to an embodiment of the invention. As shown in FIG. 3, node 302 in distributed switch fabric network 300 includes a portion of switching function 326 and is coupled to other nodes 304, 306 in distributed switch fabric network 300. Node 302 includes a transceiver channel 330, 332 dedicated to each of the other nodes 304, 306 in distributed switch fabric network 300. For example, transceiver channel 330 is dedicated to communication between node 302 and node 304. Also, transceiver channel 332 is dedicated to communication between node 302 and node 306. The two transceiver channels 330, 332 shown and two other nodes 304, 306 shown are exemplary only. The invention is not limited to the transceiver channels 330, 332 and other nodes 304, 306 shown. The invention can include any number of other nodes and corresponding transceiver channels and be within the scope of the invention. In a preferred embodiment, there are eighteen transceiver channels within a node and a total of eighteen nodes in distributed switch fabric network 300.

Node 302 also includes traffic manager 307. The function of traffic manager 307 is to collect, classify, modify (if necessary) and transport information, usually in the form of packets 314, 316 to and from other nodes 304, 306 in distributed switch fabric network 300. Traffic manager 307 can include, for example and without limitation, a processor 321, which can be a network processor, digital signal processor, and the like. Traffic manager 307 can also include memory 319, which can comprise control algorithms, and can include, but is not limited to, random access memory (RAM), read only memory (ROM), flash memory, electrically erasable programmable ROM (EEPROM), and the like. Memory 319 can contain stored instructions, tables, data, and the like, to be utilized by processor 321. Packets 314, 316 are generally intended for use by other devices within node 302 (not shown for clarity). These other device can include other processors, other memory, storage devices, and the like.

In effect, traffic manager 307 controls the incoming and outgoing packets for node 302. Traffic manager 307 determines which packets go to which transceiver channel 330, 332. In node 302, all packets 314, 316 move between traffic manager 307 and transceiver channels 330, 332. In the transmit direction, traffic manager 307 performs switching function 326 by examining a packet and selecting the correct transceiver channel 330, 332. Traffic manager 307 is coupled to transmit decoder 350, which receives packets for transmission from traffic manager 307 and distributes to appropriate transceiver channel 330, 332. As can be seen, traffic manager, in conjunction with transceiver channel 330, 332 operates as a portion of switching function 326 within node 302 for distributed switch fabric network 300.

Transceiver channel 330, 332 is disposed to send and receive a plurality of packets 314, 316 between node 302 and other nodes 304, 306 respectively. Each transceiver channel 330, 332 comprises a transmit channel and a receiver channel. For example, transceiver channel 330 comprises transmit channel 338 and receiver channel 334. Transceiver channel 332 comprises transmit channel 340 and receiver channel 336. Transmit channel 338, 340 is coupled to send outgoing packets to other nodes in distributed switch fabric network 300 upon receipt from traffic manager 307. Receiver channel 334, 336 is coupled to receive packets 314, 316 from other nodes 304, 306 in distributed switch fabric network 300 and pass along packets to traffic manager 307.

In an embodiment, each receiver channel 334, 336 can comprise buffer memory 342, 344 to store incoming packets from other nodes 304, 306. For example, receiver channel 334 comprises buffer memory 342 to store incoming packets 316 from other node 306. Receiver channel 336 comprises buffer memory 344 to store incoming packets 314 from other node 304. Buffer memory 342, 344 can be a First-in-first-out (FIFO) queue, Virtual Output Queue (VOQ), and the like.

In an embodiment, each receiver channel 334, 336 is coupled to receive multiplexer 311, which receives packets from receiver channels 334, 336. From receive multiplexer 311, packets are sent to shared memory resource 309 as a single packet stream 315. Subsequently, all packets 314, 316 are sent as a single packet stream 315 to traffic manager 307. Shared memory resource can be a First-in-first-out (FIFO) queue, Virtual Output Queue (VOQ), and the like. Together, shared memory resource 309 and buffer memories 342, 344 comprise receiver channel memory resource 323. Receiver channel memory resource 323unctions to store incoming packets 314, 316 prior to packets 314, 316 being sent to traffic manager 307.

The capacity of node 302 is determined by the capacity of traffic manager 307. In a distributed switch fabric network 300, each transceiver channel 330, 332 does not necessarily have to operate at the same capacity as traffic manager 307. Packets 314, 316 need only be adequately distributed among transceiver channels 330, 332 such that the average amount of packets processed by traffic manager 307 matches the capacity of traffic manager 307. For example, and without limitation, 1 Gigabit per second (Gb/s) transceiver channels 330, 332 can support a 2.5 Gb/s traffic manager 307. In another examples, 2.5 Gb/s transceiver channels 330, 332 can support a 10 Gb/s traffic manager 307. An advantageous feature of distributed switch fabric network 300 is that transceiver channels 330, 332 can operate at different speeds without necessarily slowing down distributed switch fabric network 300.

With a 1-to-N configuration of nodes in distributed switch fabric network 300, it is possible for variations in the amount of packets 314, 316 received by node 302 to exceed traffic manager 307 capacity and/or transceiver channel 330, 332 capacity. Storing incoming packets 314, 316 in receiver channel memory resource 323 alleviates the capacity problem by damping out incoming packet flows that exceed the capacity of either traffic manager 307 or receiver channel 334, 336. However, receiver channel memory resource 323 is limited in node 302, it is important that receiver channel memory resource 323 is allocated optimally.

In the embodiment shown, receiver channel memory resource 323 is distributed among receiver channels 334, 336 and shared memory resource 309. In the embodiment, shared memory resource 309 is larger than necessary to for any one receiver channel 334, 336, but utilizes less memory resources of node 302 than implementing only adequately sized individual buffer memories 342, 344 for each receiver channel 334, 346. In this embodiment, only a small portion of receiver channel memory resource 323 is allocated to receiver channel 334, 336, such that buffer memory 342, 344 is below that required to adequately buffer incoming packets 314, 316 using buffer memory 342, 344 alone.

The advantage of this embodiment is that a larger portion of receiver channel memory resource 323 is available to any given receiver channel 334, 336. For example, if only one receiver channel 334, 336 is operating in distributed switch fabric network 300, all of shared memory resource 309 is available for that particular receiver channel 334, 336 and more packets 314, 316 can be received before node 302 reaches capacity.

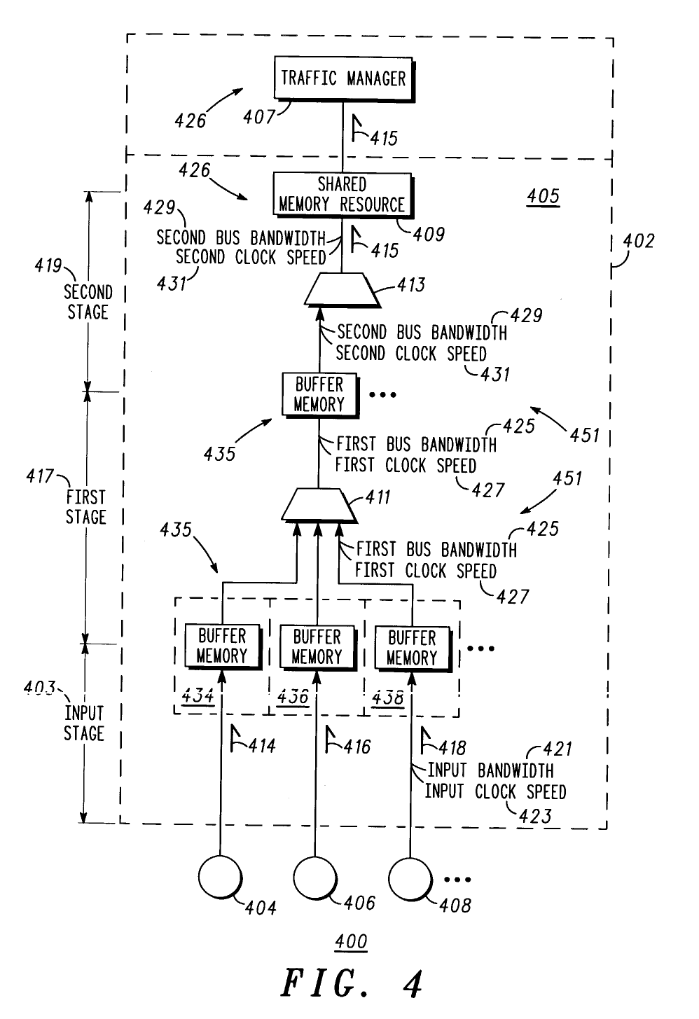

FIG. 4 illustrates a block diagram of a distributed switch fabric network 400 having, a portion of switching, function 426 according to another embodiment of the invention. As shown in FIG. 4, node 402 comprises receiver channels 434, 436, 438, which are coupled to receive a plurality of packets 414, 416, 418 from other nodes 404, 406, 408. In the embodiment shown, plurality of receiver channels 434, 436, 438 aggregate in a plurality of stages 451 within node 402 to allow a single packet stream 415 to enter shared memory resource 409.

In an embodiment, aggregating plurality of receiver channels 434, 436, 438 can including multiplexing plurality of receiver channels 434, 436, 438, via a plurality of stages 451, to form single packet stream 415. Each of the plurality of stages 451 can include its own unique bus bandwidth and unique clock speed. For example, input stage 403 receives plurality of packets 414, 416 418 from other nodes 404, 406, 408. Input stage 403 can include input bandwidth 421 and input clock speed 423. As an example and without limitation, input bandwidth can be 8 bits and input clock speed can be 125 Megahertz (MHz).

Each receiver channel 434, 436, 438 can include buffer memory 435. In the embodiment shown, buffer memory is distributed among the plurality of stages 451. Buffer memory 435 can reside at the intersection of stages. For example, a portion of buffer memory 435 resides at the intersection of input stage 403 and first stage 417. Also, a portion of buffer memory 435 resides at the intersection of first stage 417 and second stage 419. In an embodiment, receiver channel memory resource 323 is distributed among the plurality of stages 451 and shared memory resource 409.

In the embodiment shown, receiver channels 434, 436, 438 are coupled to first stage multiplexer 411. Packets 414, 416, 418 are multiplexed at first stage multiplexer 411 and output to buffer memory before entering second stage 419 and second stage multiplexer 413. Packets 414, 416, 418 are further multiplexed with packets from other receiver channels in second stage multiplexer 413 to becoming single packet stream 415. Upon becoming single packet stream 415, packets enter shared memory resource 409 prior to entering traffic manager 407 in a manner analogous with that described in reference to FIG. 3.

First stage 417 can have a first bus bandwidth 425 and first clock speed 427. First bus bandwidth 425 and first clock speed 427 can be selected to match the requirement of the total number of receiver channels 434, 436, 438 feeding first stage 417. In a preferred embodiment, first bus bandwidth 425 and first clock speed 427 can be chosen to minimize the bus bandwidth and clock speed required to process plurality of packets, 414, 416, 418 received from receiver channels 434, 436, 438. In effect, first bus bandwidth 425 and first clock speed 427 are chosen depending on input bus bandwidth 421, input clock speed 423 and the number of receiver channels 434, 436, 438 feeding into first stage 417. Input bandwidth 421 and input clock speed 423 determine the rate at which each of receiver channels 434, 436, 438 can receive packets 404, 406, 408.

For example, if input bandwidth 421 is 8 bits and input clock speed 423 is 125 MHz, then each receiver channel has a throughput of 1 Gb/s. This means that the aggregation of three receiver channels 434, 436, 438 have a combined throughput of approximately 3.0 Gb/s. First stage 417 is an aggregation of receiver channels 434, 436, 438 and it is desired to keep first bus bandwidth 425 and first clock speed 427 as low as possible, so as to lower cost and maintain efficiency of node 402, while maintaining throughput of packets 414, 416, 418. By choosing a first bus bandwidth 425 of 32 bits and taking into account input bandwidth 421, input clock speed 423 and number of receiver channels 434, 436, 438, first clock speed 427 can be calculated as:

[(125 MHz)×(3 receiver channels)]/(32 bits/8 bits)

which equals approximately 100 MHz. So, first clock speed is set at 100 MHz and first bus bandwidth is set at 32 bits. This gives a throughput for first stage 417 of approximately 3.2 Gb/s. This allows the multiplexing of receiver channels 434, 436, 438 into first stage 417 and a throughput of packets 414, 416, 418 in first stage 417 approximately equal to the three receiver channels 434, 436, 438 having input bandwidth 421 and input clock speed 423.

In an embodiment, second stage multiplexer 413 can multiplex any number of plurality of first stages 417 into at least one second stage 419. Second stage 419 can have a second bus bandwidth 429 and second clock speed 431. Second bus bandwidth 429 and second clock speed 431 can be selected to match the throughput requirement of the total number of first stages 417 feeding second stage 419. In a preferred embodiment, second bus bandwidth 429 and second clock speed 431 can be chosen to minimize the bus bandwidth and clock speed required to process plurality of packets 414, 416, 418; received from first stage 417. In effect, second bus bandwidth 429 and second clock speed 431 are chosen depending on first bus bandwidth 425, first clock speed 427 and the number of first stages 417 feeding into second stage 419.

Continuing with the example above, first bus bandwidth 425 is 32 bits and first clock speed 427 is approximately 100 MHz. In a preferred embodiment, node 402 comprises eighteen receiver channels, with six groups of three receiver channels multiplexed into first stage 417. With a total of six first stages 417 feeding second stage (18 receiver channels aggregated in groups of three to feed second stage) then each first stage 417 has a throughput of 3.2 (Gb/s) as calculated above, with the aggregation of the six first stages 417 having a throughput of approximately 19.2 Gb/s. Second stage 419 is an aggregation of first stages 417 and it is desired to keep second bus bandwidth 429 and second clock speed 431 as low as possible, so as to lower cost and maintain efficiency of node 402, while maintaining throughput of packets 414, 416, 418. By choosing a second bus bandwidth 425 of 128 bits and taking into account first bus bandwidth 425, first clock speed 427 and number of first stage 417, second clock speed 431 can be calculated as:

[(100 MHz)×(6 first stages)]/(128 bits/32 bits)

which equals 150 MHz. So, second clock speed is set at 150 MHz and second bus bandwidth is set at 128 bits. This gives a throughput for second stage 419 of approximately 19.2 Gb/s. This allows the multiplexing of first stages 417 into second stage 419 and a throughput of packets 414, 416, 418 in second stage 419 approximately equal to the six first stages 417 having first bus bandwidth 425 and input clock speed 427.

In a preferred embodiment, node 402 comprises eighteen receiver channels, with six groups of three receiver channels multiplexed into first stage 417 and the six groups of first stages 417 multiplexed into a single second stage 419. However, the number of receiver channels, first stages, second stages, the number of stages in general, and the above calculation are exemplary and not limiting of the invention. Any number of receiver channels, first stages, second stages, and any number of other stages are within the scope of the invention. Also, multiplexing any number of receiver channels together to feed first stage 417 is within the scope of the invention. In addition, multiplexing any number of first stages together to feed second stage 419 is within the scope of the invention.

Software blocks that perform embodiments of the invention can be part of computer program modules comprising computer instructions, such as control algorithms, that are stored in a computer readable medium such as memory described above. Computer instructions can instruct processors to perform methods of processing a plurality of packets.

As described above, plurality of packets 414, 416, 418 from receiver channels 434, 436, 438 are aggregated in plurality of stages 451 prior to entering shared memory resource 409 and traffic manager 407. The aforementioned embodiments have the advantage of more efficient utilization of memory resources within node 402. Another advantages is minimizing the clock speed required to process packets within node 402. Another more receiver channels are multiplexed together, a given bus bandwidth within a stage can be enlarged or the clock speed can be increased to accommodate the increased packet throughput.

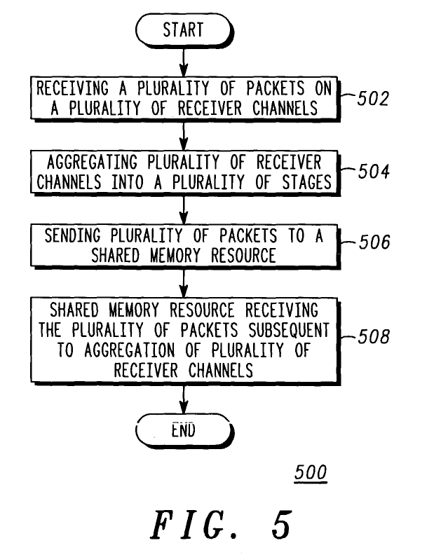

FIG. 5 illustrates a flow diagram 500 of a method of the invention according to an embodiment of the invention. In step 502, at a node having at least a portion of a switching function, a plurality of packets are received on a plurality of receiver channels. In step 504, plurality of receiver channels are aggregated into a plurality of stages within the node. Step 506 includes sending the plurality of packets to a shared memory resource within the node. The shared memory resource is coupled to receive the plurality of packets from the plurality of receiver channels. In an embodiment, the shared memory resource receives the plurality of packets subsequent to the plurality of receiver channels being aggregated into the plurality of stages.

While we have shown and described specific embodiments of the present invention, further modifications and improvements will occur to those skilled in the art. It is therefore to be understood that appended claims are intended to cover all such modifications and changes as fall within the true spirit and scope of the invention.

1. A distributed switch fabric network, comprising:
a plurality of nodes, wherein each of the plurality of nodes includes at least a portion of a switching function;
a plurality of receiver channels within each of the plurality of nodes, wherein the plurality of receiver channels are coupled to receive a plurality of packets, and wherein the plurality of receiver channels aggregate in a plurality of stages within each of the plurality of the nodes; and
a shared memory resource within each of the plurality of nodes, wherein the shared memory resource is coupled to receive the plurality of packets from the plurality of receiver channels.

2. The network of claim 1, wherein the shared memory resource receives the plurality of packets from the plurality of receiver channels subsequent to the plurality of receiver channels aggregating in the plurality of stages.

3. The network of claim 1, wherein the plurality of packets are multiplexed into a single packet stream prior to entering the shared memory resource.

4. The network of claim 1, wherein each of the plurality of nodes comprises:
a first stage multiplexer, wherein the first stage multiplexer multiplexes at least a portion of the plurality of receiver channels into a plurality of first stages; and
a second stage multiplexer, wherein the second stage multiplexer multiplexes at least a portion of the plurality of first stages into at least one second stage.

5. The network of claim 4, wherein the plurality of first stages have a first bus bandwidth and a first clock speed, and wherein the at least one second stage has a second bus bandwidth and a second clock speed.

6. The network of claim 5, wherein the plurality of receiver channels have an input bandwidth, and wherein the input bandwidth is less than the first bus bandwidth.

7. The network of claim 1, wherein each of the plurality of stages has a unique bus bandwidth and a unique clock speed.

8. The network of claim 1, further comprising each of the plurality of receiver channels having a buffer memory, and wherein the buffer memory of each of the plurality of receiver channels is distributed among the plurality of stages.

9. The network of claim 1, further comprising each of the plurality of nodes having a receiver channel memory resource, and wherein the receiver channel memory resource is distributed among the plurality of stages and the shared memory resource.

10. A node in a distributed switch fabric network, comprising:
a plurality of receiver channels, wherein the plurality of receiver channels are coupled to receive a plurality of packets, and wherein the plurality of receiver channels aggregate in a plurality of stages within the node; and
a shared memory resource within the node, wherein the shared memory resource is coupled to receive the plurality of packets from the plurality of receiver channels.

11. The node of claim 10, wherein the shared memory resource receives the plurality of packets from the plurality of receiver channels subsequent to the plurality of receiver channels aggregating in the plurality of stages.

12. The node of claim 10, wherein the plurality of packets are multiplexed into a single packet stream prior to entering the shared memory resource.

13. The node of claim 10, wherein the node further comprises:
a first stage multiplexer, wherein the first stage multiplexer multiplexes at least a portion of the plurality of receiver channels into a plurality of first stages; and
a second stage multiplexer, wherein the second stage multiplexer multiplexes at least a portion of the plurality of first stages into at least one second stage.

14. The node of claim 13, wherein the plurality of first stages have a first bus bandwidth and a first clock speed, and wherein the at least one second stage has a second bus bandwidth and a second clock speed.

15. The node of claim 14, wherein the plurality of receiver channels have an input bandwidth, and wherein the input bandwidth is less than the first bus bandwidth.

16. The node of claim 10, wherein each of the plurality of stages has a unique bus bandwidth and a unique clock speed.

17. The node of claim 10, further comprising each of the plurality of receiver channels having a buffer memory, and wherein the buffer memory of each of the plurality of receiver channels is distributed among the plurality of stages.

18. The node of claim 10, further comprising a receiver channel memory resource, and wherein the receiver channel memory resource is distributed among the plurality of stages and the shared memory resource.

19. A method of processing a plurality of packets in a distributed switch fabric network, comprising:
at a node having at least a portion of a switching function, receiving a plurality of packets on a plurality of receiver channels;
aggregating the plurality of receiver channels into a plurality of stages within the node; and
sending the plurality of packets to a shared memory resource within the node, wherein the shared memory resource is coupled to receive the plurality of packets from the plurality of receiver channels.

20. The method of claim 19, further comprising the shared memory resource receiving the plurality of packets, wherein the shared memory resource receives the plurality of packets from the plurality of receiver channels subsequent to the plurality of receiver channels aggregating in the plurality of stages.

21. The method of claim 19, wherein the plurality of packets are multiplexed into a single packet stream prior to entering the shared memory resource.

22. The method of claim 19, wherein aggregating the plurality of receiver channels comprises:
multiplexing at least a portion of the plurality of receiver channels into a plurality of first stages; and
multiplexing at least a portion of the plurality of first stages into at least one second stage.

23. The method of claim 22, wherein the plurality of first stages have a first bus bandwidth and a first clock speed, and wherein the at least one second stage has a second bus bandwidth and a second clock speed.

24. The method of claim 23, wherein the plurality of receiver channels have an input bandwidth, and wherein the input bandwidth is less than the first bus bandwidth.

25. The method of claim 19, wherein each of the plurality of stages has a unique bus bandwidth and a unique clock speed.

26. The method of claim 19, wherein each of the plurality of receiver channels comprises a buffer memory, and wherein distributing the buffer memory among the plurality of stages.

27. The method of claim 19, wherein the node comprise a receiver channel memory resource, and wherein distributing the receiver channel memory resource among the plurality of stages and the shared memory resource.

28. A method of processing packets in a node of a distributed switch fabric network:
receiving a plurality of packets on a plurality of receiver channels;
aggregating the plurality of receiver channels into a plurality of stages within the node; and
sending the plurality of packets to a shared memory resource within the node, wherein the shared memory resource is coupled to receive the plurality of packets from the plurality of receiver channels.

29. The method of claim 28, further comprising the shared memory resource receiving the plurality of packets, wherein the shared memory resource receives the plurality of packets from the plurality of receiver channels subsequent to the plurality of receiver channels aggregating in the plurality of stages.

30. The method of claim 28, wherein the plurality of packets are multiplexed into a single packet stream prior to entering the shared memory resource.

31. The method of claim 28, wherein aggregating the plurality of receiver channels comprises:
multiplexing at least a portion of the-plurality of receiver channels into a plurality of first stages; and
multiplexing at least a portion of the plurality of first stages into at least one second stage.

32. The method of claim 28, wherein each of the plurality of receiver channels comprises a buffer memory, and wherein distributing the buffer memory among the plurality of stages.

33. The method of claim 28, wherein the node comprises a receiver channel memory resource, and wherein distributing the receiver channel memory resource among the plurality of stages and the shared memory resource.

34. A computer-readable medium containing computer instructions for instructing a processor to perform a method of processing packets in a node of a distributed switch fabric, the instructions comprising:
receiving a plurality of packets on a plurality of receiver channels;
aggregating the plurality of receiver channels into a plurality of stages within the node; and
sending the plurality of packets to a shared memory resource within the node, wherein the shared memory resource is coupled to receive the plurality of packets from the plurality of receiver channels.

35. The method of claim 34, further comprising the shared memory resource receiving the plurality of packets, wherein the shared memory resource receives the plurality of packets from the plurality of receiver channels subsequent to the plurality of receiver channels aggregating in the plurality of stages.

36. The method of claim 34, wherein the plurality of packets are multiplexed into a single packet stream prior to entering the shared memory resource.

37. The method of claim 34, wherein aggregating the plurality of receiver channels comprises:
multiplexing at least a portion of the plurality of receiver channels into a plurality of first stages; and
multiplexing at least a portion of the plurality of first stages into at least one second stage.

38. The method of claim 34, wherein each of the plurality of receiver channels comprises a buffer memory, and wherein distributing the buffer memory among the plurality of stages.

39. The method of claim 34, wherein the node comprises a receiver channel memory resource, and wherein distributing the receiver channel memory resource among the plurality of stages and the shared memory resource.
